(19) United States
(12) Patent Application Publication
(10) Pub. No.: US 2009/0151003 A1
(43) Pub. Date: Jun. 11, 2009

(54) RECEIVER CAPABLE OF MANAGING CONDITIONAL ACCESS SOFTWARE OBJECTS, DOWNLOAD-BASED CONDITIONAL ACCESS SYSTEM INCLUDING THE RECEIVER, AND METHOD FOR MANAGING THE CONDITIONAL ACCESS SOFTWARE

(75) Inventors: Jin Young MOON, Daejon (KR); Jung Tae KIM, Daejon (KR); Jong Youl PARK, Seoul (KR); Eui Hyun PAIK, Daejon (KR); Kwang Rho PARK, Daejon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/184,817

(22) Filed: Aug. 1, 2008

(30) Foreign Application Priority Data
Dec. 10, 2007 (KR) 10-2007-127906

(51) Int. Cl. G06F 21/00

(52) U.S. Cl. 726/27

(57) ABSTRACT

Provided are a receiver with a CA function based on software download, a CA system including the receiver, and a method for managing CA software executed by the receiver. The receiver includes a CA software management means, a download means, a demultiplexer, and a descrambler. The CA software management means performs an overall management operation including the download, execution, state control and termination of a plurality of CA softwares. The download means downloads the CA software from a CA software download server at the request of the CA software management means. The demultiplexer receives scrambled multimedia contents and a CA message and transfers the CA message to the CA software management means. The descrambler receives a descrambling key extracted from the CA message by means of the CA software and descrambles the scrambled multimedia contents with the descrambling key. Thus, a plurality of CA softwares can be operated in one receiver (e.g., a settop box). Also, a plurality of CA softwares can be downloaded beforehand or timely. Also, it is possible to provide a rapid change of running CA software.

### CROSS-REFERENCE TO RELATED APPLICATIONS

This application claims priority under 35 U.S.C. §119 to Korean Patent Application No. 10-2007-0127906, filed on Dec. 10, 2007, the disclosure of which is incorporated herein by reference in its entirety.

### BACKGROUND OF THE INVENTION

1. Field of the Invention

The present disclosure relates to a receiver in a software download-based conditional access (CA) system and a method for operating the same, and more particularly, to a receiver in a software download-based CA system and a method for operating the same, which can manage execution of a plurality of CA software objects by downloading a CA software and timely objectifying and/or initializing the downloaded CA software to control execution of the downloaded CA software.

2. Description of the Related Art

A conditional access (CA) system is a content security solution that allows only a qualified subscriber to watch a corresponding channel in a pay TV system.

The CA system interrupts an access of an unqualified receiver to contents by scrambling moving pictures and data contents and encrypting/decrypting a control word and component keys. To this end, a head-end server transmits scrambled contents to a settop box.

An access control module of the settop box recovers the scrambled contents through a descrambling operation. For conditional access, the same control word (CW) is used as a scrambling key and a descrambling key. For security of the CW, the server encrypts a CW with an authentication key and transmits the encrypted CW through an entitlement control message. The authentication key is encrypted using a subscriber secret key, and the encrypted authentication key is transmitted through an entitlement management message.

A subscriber management system associated with the CA system manages customer information. Using only CA-related information, the subscriber management system generates an entitlement management message and an entitlement control message according to the subscription/unsubscription of a subscriber so that a new subscriber can receive a subscribed broadcast channel and an unsubscribed subscriber cannot receive a broadcast any more.

The subscriber secret key is installed in, for example, a smart card and is distributed to a subscriber through the subscriber management system.

A receiver receives an entitlement control message and an entitlement management message to perform a message check operation. Thereafter, the receiver performs a key decryption operation in the reverse order of the encryption operation performed by the server. The entitlement management message is decrypted with the subscriber secret key installed in the smart card, thereby extracting the authentication key. The CW included in the entitlement control key is decrypted with the authentication key, and the received contents are descrambled with the decrypted CW.

Through the above operations, the CA system allows only an entitled user to access the contents.

A software download-based CA system is being proposed to prevent holding the market by a specific product and the need to replace a settop box when a content provider changes or adds a CA system.

The software download-based CA system downloads bytecodes of a software module, which decrypts an encryption key and CW in an entitlement control message and an entitlement management message to extract a descrambling key, through a network, and executes the downloaded bytecodes by class loading mechanism at a settop box.

In the conventional software download-based CA system, CA software is downloaded through a conventional broadcasting network or newly-downloaded CA software is objectified and executed at the time when software update is needed.

However, as the number of channels increases and also contents are diversified, the requirements for a CA system are also diversified. What is therefore required is a scheme for operating one or more CA softwares in one settop box.

Particularly, in an IPTV system providing hundreds of channels and various programs in one channel, various content providers may present the requirements for different CA systems for respective channels or for respective programs in one channel.

What is therefore required is a CA software execution management technique that can overcome the limitation of the conventional software download-based CA system and can support the efficient execution of a plurality of CA softwares, for a rapid switch between channels.

### SUMMARY

Therefore, an object of the present invention is to provide a receiver with a CA function for managing execution of a plurality of CA softwares for a rapid switch between channels and a method for managing execution of CA softwares.

Another object of the present invention is to provide a receiver with a CA function for providing a stable CA service by downloading necessary CA software beforehand or timely for a continuous CA service and a method for managing download of CA software.

Another object of the present invention is to provide a receiver with a CA function for providing, when different CA softwares are necessary for the respective channels or programs, a rapid switch between CA softwares by managing one ore more CA softwares on the basis of execution states and a method for controlling a state change of CA software.

To achieve these and other advantages and in accordance with the purpose(s) of the present invention as embodied and broadly described herein, a receiver having CA function based on software download in accordance with an aspect of the present invention includes: a CA software management means for performing an overall management operation including the download, execution, state control and termination of a plurality of CA softwares; a download means for downloading the CA software from a CA software download server at the request of the CA software management means; a demultiplexer for receiving scrambled multimedia contents and a CA message and transferring the CA message to the CA software management means; and a descrambler for receiving a descrambling key extracted from the CA message by means of the CA software and descrambling the scrambled multimedia contents with the descrambling key.

Herein, the CA software management means may include: a message analysis unit for analyzing the CA message; a CA software download request unit for downloading the necessary CA software to the download means beforehand or timely; and a CA software execution management unit for executing the CA software according to the analysis results of the message analysis unit and controlling a state change.

To achieve these and other advantages and in accordance with the purpose(s) of the present invention, a CA system based on software download in accordance with another aspect of the present invention includes: a CA server for scrambling multimedia contents and transmitting the scrambled multimedia contents together with a CA message; the above-described receiver; and a subscriber management unit for managing information about multimedia content service subscribers and transferring the subscriber information to the CA server and the receiver.

To achieve these and other advantages and in accordance with the purpose(s) of the present invention, a method for managing a CA software executed by a CA software management means in a receiver of a software download-based CA system in accordance with another aspect of the present invention includes: analyzing a CA message that is currently stored or received; requesting download of a CA software according to the analysis results; initializing the downloaded CA software; and controlling a state change of one or more CA softwares that are currently running.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a block diagram of a CA system according to an embodiment of the present invention;

FIG. 2 illustrates a block diagram and an execution flow of a CA software management unit managing a plurality of CA softwares according to an embodiment of the present invention;

FIG. 3 is a stage diagram of a CA software according to an embodiment of the present invention;

FIG. 4 is a flow diagram illustrating a process for the CA software management unit to request download of a necessary CA software in advance when a settop box is booted, according to an embodiment of the present invention;

FIG. 5 is a flow diagram illustrating a process for the CA software management unit to request download of a necessary CA software in advance by means of a CA message for a download request, according to an embodiment of the present invention;

FIG. 6 is a flow diagram illustrating a process for the CA software management unit to request download of a currently-necessary CA software, according to an embodiment of the present invention;

FIG. 7 is a flow diagram illustrating a process for the CA software management unit to initialize a downloaded CA software, according to an embodiment of the present invention;

FIG. 8 is a flow diagram illustrating a process for the CA software management unit to start execution of a CA software object, according to an embodiment of the present invention;

FIG. 9 is a flow diagram illustrating a process for the CA software management unit to restart execution of a CA software object, according to an embodiment of the present invention;

FIG. 10 is a flow diagram illustrating a process for the CA software management unit to pause execution of a CA software object to change the CA software object into a “waiting” state, according to an embodiment of the present invention;

FIG. 11 is a flow diagram illustrating a process for the CA software management unit to terminate execution of a CA software object, according to an embodiment of the present invention; and

FIG. 12 is a flow diagram illustrating a process for the CA software management unit to analyze and process a CA message, according to an embodiment of the present invention.

### DETAILED DESCRIPTION OF EMBODIMENTS

Hereinafter, specific embodiments of the present invention will be described in detail with reference to the accompanying drawings. The present invention is intended to provide an apparatus and method for download processing and executing of a conditional access (CA) system based on software download.

Throughout the specification including the appended claims, the term “conditional access (CA) message” is used to collectively denote an entitlement control message, an entitlement management message, and CA-related messages including messages related to download command or request for a CA software. The CA-related messages are denoted by the term “CA message”, except for the case where a direct description of the entitlement control message or the entitlement management message is necessary.

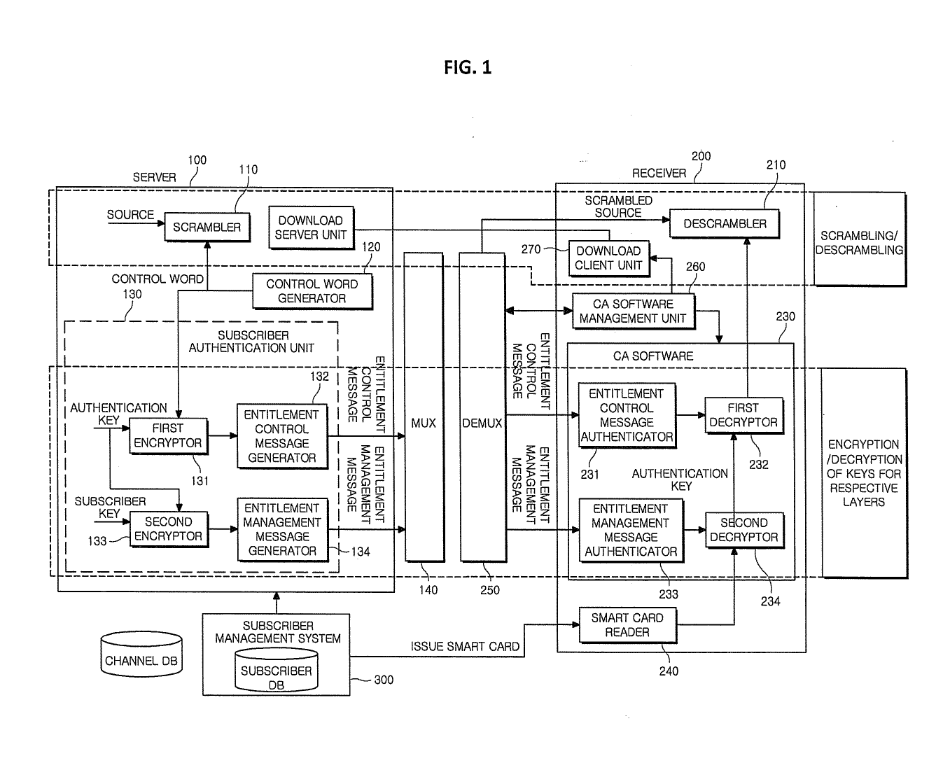

FIG. 1 is a block diagram of a CA system according to an embodiment of the present invention.

Referring to FIG. 1, the CA system includes a server 100 and a receiver 200 and controls reception of contents according to subscriber types in association with a subscriber management system 300.

The server 100 performs a CA process using a scrambler 110, a control word generator 120, and a subscriber authentication unit 130 that includes a first encryptor 131, an entitlement control message generator 132, a second encryptor 133, and an entitlement management message generator 134.

For conditional access, the server 100 uses the same key, i.e., a control word (CW), as a scrambling key and a descrambling key. For the security of the CW, the first encryptor 131 encrypts the CW with an authentication key. The entitlement control message generator 132 generates an entitlement control message including the encrypted CW.

The second encryptor 133 encrypts the authentication key with a subscriber secret key. The entitlement management message generator 134 generates an entitlement management message including the encrypted authentication key.

The multiplexer (MUX) 140 may multiplex contents, the entitlement control message, and the entitlement management message prior to transmission.

The receiver 100 includes a descrambler 210, an entitlement control message authenticator 231, a first decryptor 232, an entitlement management message authenticator 233, a second decryptor 234, a smart card reader 240, a demultiplexer (DEMUX) 250, a CA software management unit 260, and a download unit 270.

The second decryptor 234 receives an entitlement management message from the entitlement management message authenticator 233, extracts a subscriber key from a smart card by means of the smart card reader 240, decrypts the entitlement management message with the subscriber key to extract an authentication key, and provides the authentication key to the first decryptor 232.

The first decryptor 232 receives an entitlement control message from the entitlement control message authenticator 231, decrypts the entitlement control message with the authentication key to extract a CW (i.e., a descrambling key), and provides the CW to the descrambler 210. The descrambler 210 descrambles a scrambled source with the CW in order to allow the use of contents.

The entitlement control message authenticator 231, the first decryptor 232, the entitlement management message authenticator 233, and the second decryptor 234 constitute a module included in downloadable CA software 230.

The CA software management unit 260 performs an overall management operation including the state change control, execution and download of the CA software 230. At the request of the CA software management unit 260, the download unit 270 downloads CA software from a CA software download server.

Although FIG. 1 illustrates that the download unit 270 downloads a CA software from the server 100 transmitting a CA message, the present invention is not limited to this. For example, the download unit 270 may download the CA software from another separate server over an out-of-band (OOB) channel.

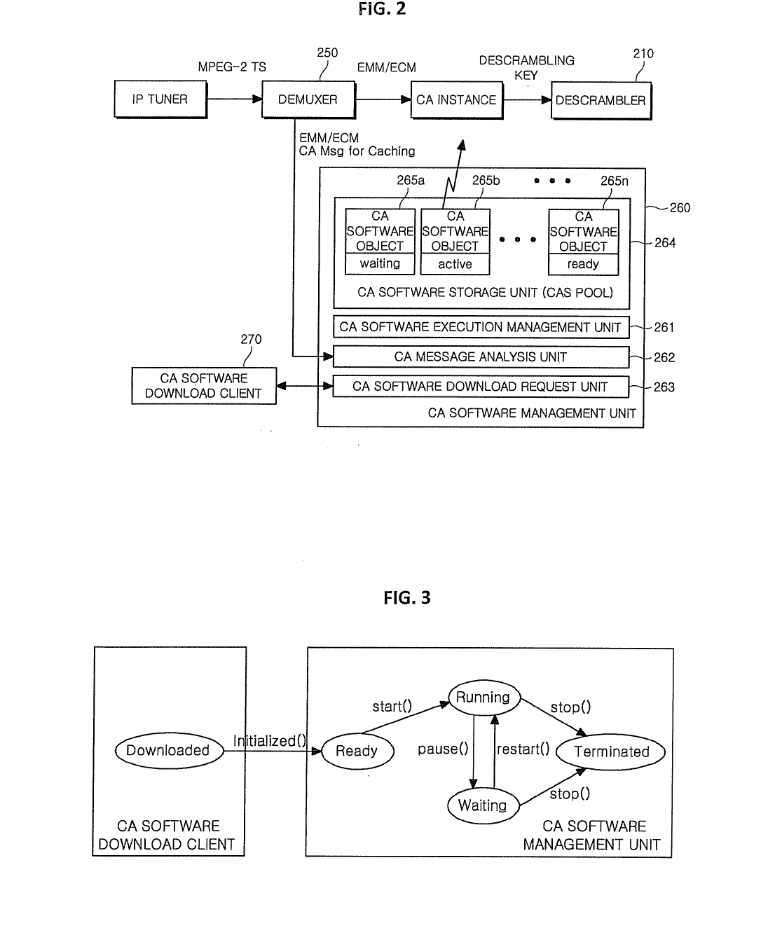

FIG. 2 illustrates a block diagram of the CA software management unit 260 and also an execution flow in the receiver 200 of the software download-based CA system capable of executing a plurality of CA softwares.

Referring to FIG. 2, the CA software management unit 260 includes: a CA message analysis unit 262 for analyzing the CA message; a CA software download request unit 263 for requesting download of the CA software to the download unit 270 in advance or if necessary; and a CA software execution management unit 261 for executing the CA software according to the analysis results of the CA message analysis unit 262 and controlling a state change.

The CA software management unit 260 further includes a CA software storage (CAS pool) 264 for storing a plurality of the downloaded CA softwares, in order to manage a plurality of CA software objects 265a˜265c.

If a message received from the DEMUX 250 is an entitlement management message or an entitlement control message from which a descrambling key is extracted, the CA message analysis unit 262 provides the message to a corresponding one of the CA software objects 265a˜265c.

If the corresponding CA software object 265b is unable to process the message, the CA software execution management unit 261 makes a change to another suitable CA software that can process the message. Each of the CA software objects 265a˜265c is managed on a state basis.

At the booting time or when a cashing message among CA-related messages is received, the CA software download request unit 263 requests a CA software download client 270 to download CA software beforehand. If a CA suitable software for processing the received entitlement management or control message is not currently received, the CA software download request unit 263 requests the CA software download client 270 to download the CA software immediately.

The CA software objects 265a˜265c are stored and managed in the CA software storage 264.

In a CA-related execution flow, an IP tuner transfers a received packet to the DEMUX 250 on the basis of MPEG2-TS and the DEMUX 250 transfers a CA message to the CA message analysis unit 262. Under the management of the CA software execution management unit 261, the CA software object 265b extracts a descrambling key from the CA message and transfers the descrambling key so that received contents can be descrambled.

FIG. 3 is a state diagram of CA software according to an embodiment of the present invention. FIG. 3 shows a state change that occurs when a CA software object is downloaded by the CA software download client 270 of a settop box.

Referring to FIG. 3, when CA software is initially downloaded, it is in a “downloaded” state. Thereafter, the CA software is initialized into a “ready” state for execution. The CA software can change only from the “ready” state into a “running” state where the execution is started. The CA software may change from the “running” state into a “waiting” state after a pause, or may change from the “running” state into a “terminated” state upon termination. A change between the “running” state and the “waiting” state may be repeated by pause and restart.

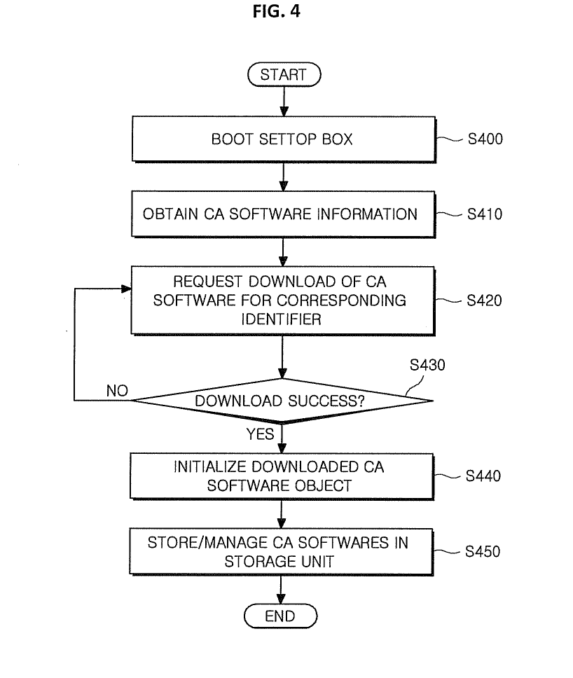

FIGS. 4 through 12 are flow diagrams illustrating a CA software management method according to an embodiment of the present invention. Hereinafter, the CA software management method will be described in detail with reference to FIGS. 4 through 12.

FIG. 4 is a flow diagram illustrating a process for the CA software management unit 260 to request download of necessary CA software in advance when a settop box is booted, according to an embodiment of the present invention.

If a CA software is downloaded in advance when the receiver 200 is booted, it is possible to reduce a driving time of the receiver 200 after a channel change.

Referring to FIG. 4, after or while the settop box is booted (in operation S400), the CA software management unit 260 receives CA software information of a corresponding channel from the DEMUX 250 (in operation S410). Herein, the CA software information includes a CA software identifier and a download server address. Alternatively, CA messages used in the software download-based CA system may commonly include CA software identifiers (e.g., a CA software provider identifier and a CA software system identifier) that are determined by a CA software provider.

Using these identifiers, the CA software management unit 260 requests the CA software download client 270 to download suitable CA software (in operation S420). The CA software management unit 260 repeats a download attempt until the download request is successful or until the number of times of the repetitions reaches a predetermined maximum number (in operation S430).

The CA software management unit 260 initializes a downloaded CA software object into an executable state (in operation S440). According to a download policy, the CA software management unit 260 may request the CA software download client 270 to download one CA software or to download a plurality of CA softwares for the respective channels or the respective channel groups. The CA software management unit 260 stores and manages a plurality of the downloaded CA softwares in the CA software storage 264 (in operation S450).

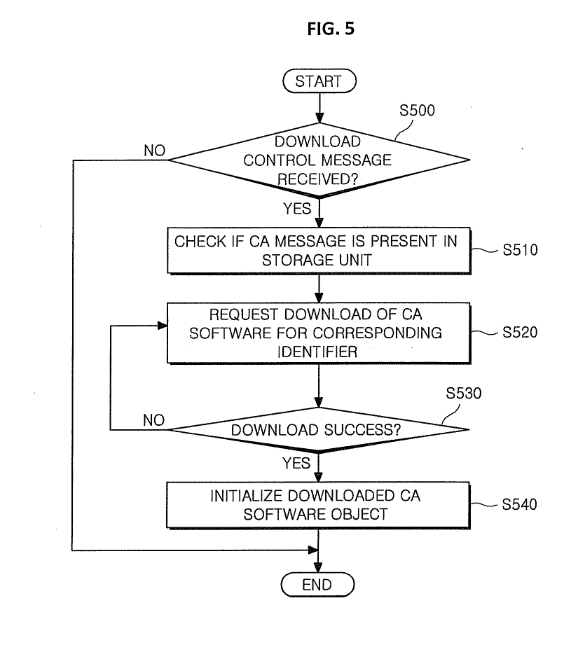

FIG. 5 is a flow diagram illustrating a process for the CA software management unit 260 to request download of necessary CA software in advance by means of a CA message for a download request, according to an embodiment of the present invention.

Referring to FIG. 5, if the CA software management unit 260 receives a download control message for commanding to download a CA software in advance when a change occurs in a CA software serviced in one channel (in operation S500), the CA software management unit 260 transfers the corresponding CA software identifier to the CA software download client 270 to request download of a CA software (in operation S520).

Before the software download request, the CA software management unit 260 checks whether the corresponding CA software is already downloaded in the CA software storage 264 (in operation S510). The CA software management unit 260 repeats a download attempt until the download request is successful or until the number of times of the repetitions reaches a predetermined maximum number (in operation S530). The CA software management unit 260 initializes a downloaded CA software object into an executable state (in operation S540).

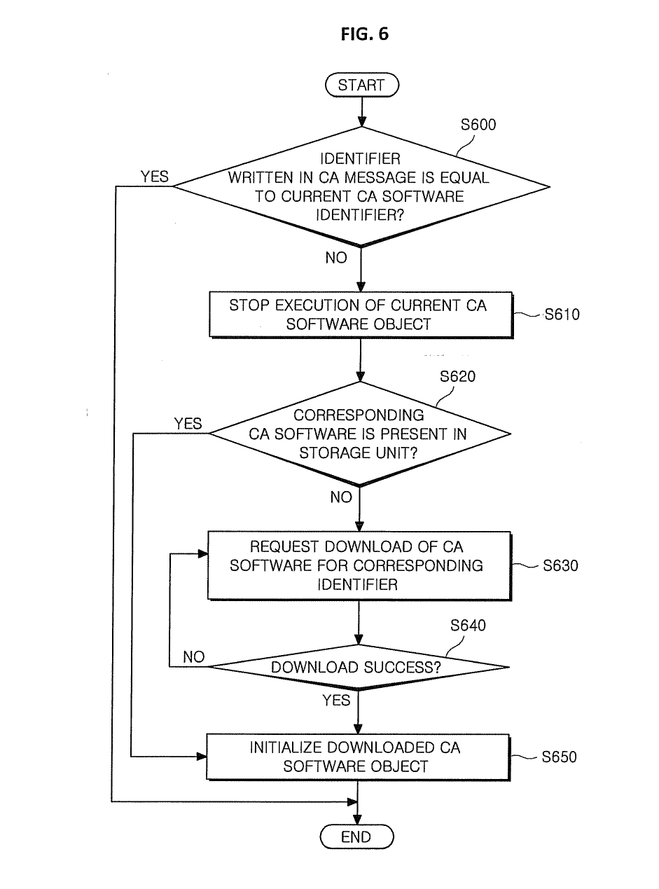

FIG. 6 is a flow diagram illustrating a process for the CA software management unit 260 to request download of currently-necessary CA software, according to an embodiment of the present invention. FIG. 6 illustrates a process for requesting download of CA software capable of processing an entitlement management message or an entitlement control message, if it fails to beforehand download CA software to process the entitlement management message or the entitlement control message.

Referring to FIG. 6, if a CA software identifier written in the entitlement management message or the entitlement control message is different from an identifier of a currently-running CA software (in operation S600), the CA software management unit 260 pauses execution of the currently-running CA software object (in operation S610) and checks whether the corresponding CA software is present in the CA software storage 264 (in operation S620). If the corresponding CA software is not present in the CA software storage 264, the CA software management unit 260 requests the CA software download client 270 to download a new CA software corresponding to the CA software identifier (in operation S630). The CA software management unit 260 repeats a download attempt until the download request is successful or until the number of times of the repetitions reaches a predetermined maximum number (in operation S640). The CA software management unit 260 initializes a downloaded CA software object into an executable state (in operation S650).

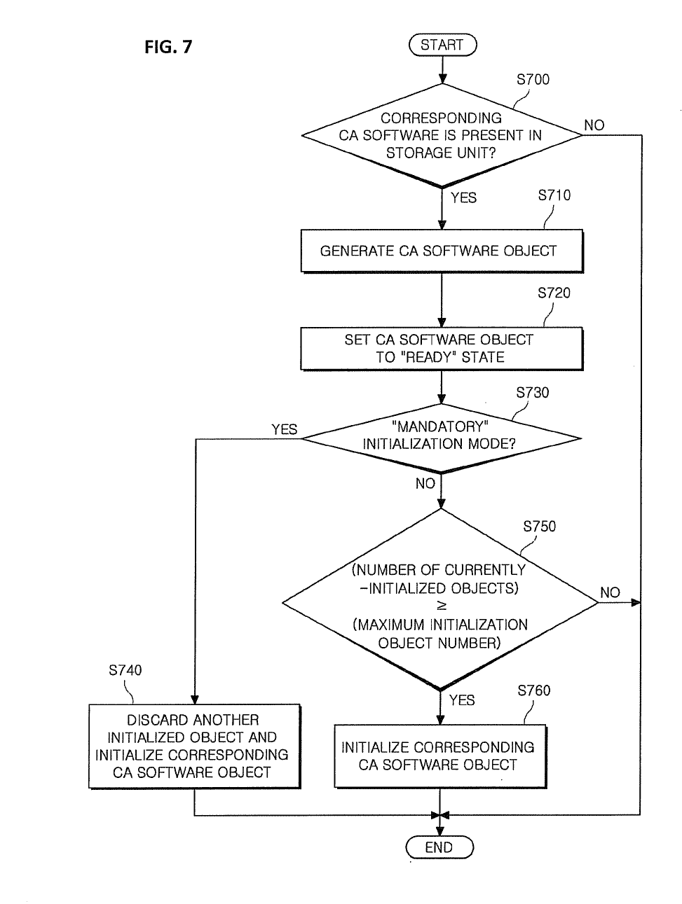

FIG. 7 is a flow diagram illustrating a process for the CA software management unit 260 to initialize downloaded CA software, according to an embodiment of the present invention. FIG. 7 illustrates a process for changing downloaded CA software from a “downloaded” state into a “ready” state, i.e., an executable state.

Referring to FIG. 7, if a CA software with a corresponding CA software identifier is present in the CA software storage 264 (in operation S700), the CA software management unit 260 generates a CA software object with bytecodes (in operation S710). Thereafter, the CA software management unit 260 sets the CA software to a “ready” state (in operation S720).

The initialization has a “mandatory” mode and an “optional” mode. The “mandatory” mode supports initialization absolutely, while the “optional” mode supports initialization only if possible.

The CA software management unit 260 determines the mode of the initialization (in operation S730). If the initialization is the “optional” mode (in operations S730), the CA software management unit 260 compares the number of currently-initialized objects with the maximum initialization object number (in operation S750). If the number of the currently-initialized objects is smaller than the maximum initialization object number (in operation S750), the CA software management unit 260 initializes the corresponding object (in operation S760). On the other hand, if the number of the currently-initialized objects is equal to or larger than the maximum initialization object number (in operation S750), the CA software management unit 260 pauses the initialization. In this case, the initialization fails.

On the other hand, if the initialization is the “mandatory” mode (in operations S730), the CA software management unit 260 completes initialization of the corresponding CA software even while discarding another initialized object (in operation S740). If the CA software is already downloaded, the initialization may be set to the “optional” mode. On the other hand, if the CA software is currently downloaded, the initialization may be initialized to the “mandatory” mode.

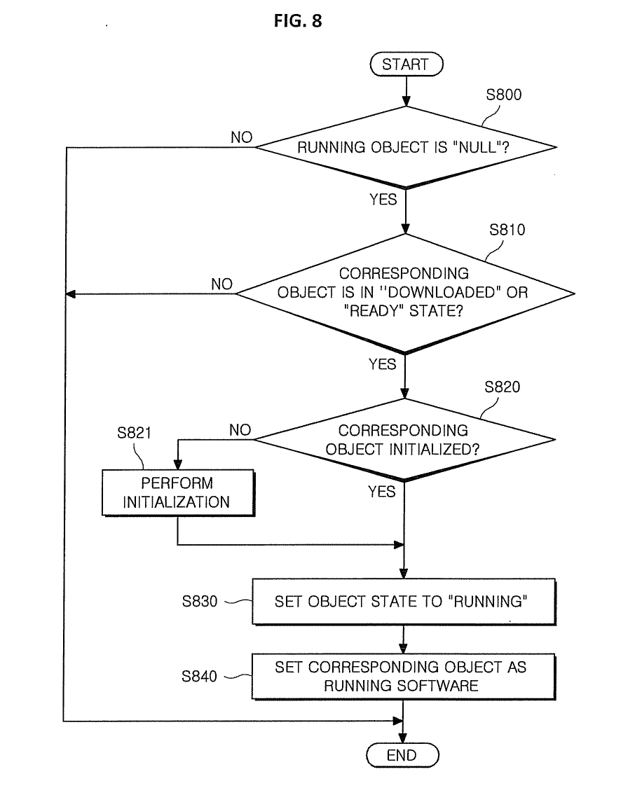

FIG. 8 is a flow diagram illustrating a process for the CA software management unit 260 to start execution of a CA software object, according to an embodiment of the present invention. FIG. 8 illustrates a process for executing a CA software object for the first time.

Referring to FIG. 8, in order to start execution of a CA software, the CA software management unit 260 checks whether a target CA software object is “null” (in operation S800). When termination of execution of the previous CA software object or an execution waiting operation is performed in order to prevent a collision, a running CA software object becomes “null”. Therefore, if the target CA software object is not “null”, the execution start operation is terminated by regarding the target CA software object as a running object.

Thereafter, the CA software management unit 260 determines whether the corresponding CA software object is in an executable state (i.e., a “downloaded” state or a “ready” state) (in operation S810). If the corresponding CA software object is in an executable state (in operation S810), the CA software management unit 260 checks whether the corresponding CA software object is already initialized (in operation S820). If the corresponding CA software object is not yet initialized (in operation S820), the CA software management unit 260 initializes the corresponding CA software object into a “ready” state (in operation S821).

Thereafter, the CA software management unit 260 changes the corresponding CA software object into a “running” state (in operation S830) and sets the CA software object as a running CA software (S840).

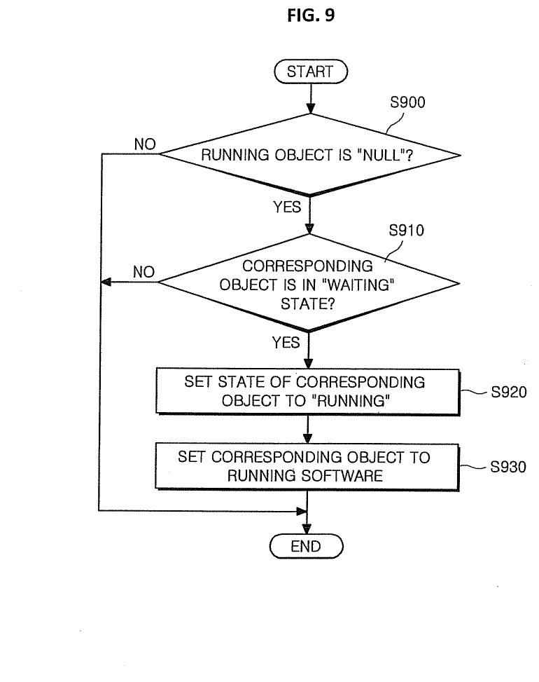

FIG. 9 is a flow diagram illustrating a process for the CA software management unit 260 to restart execution of a CA software object, according to an embodiment of the present invention. FIG. 9 illustrates a process for restarting execution of a CA software object that is temporarily in a “waiting” state.

Referring to FIG. 9, in order to restart execution of CA software, the CA software management unit 260 checks whether a currently-running CA software object is “null” (in operation S900). If the currently-running CA software object is “null” (in operation S900), the CA software management unit 260 performs the subsequent operation.

Thereafter, the CA software management unit 260 determines whether the corresponding CA software object is in a “waiting” state (in operation S910). If the corresponding CA software object is in a “waiting” state (in operation S910), the CA software management unit 260 changes the object state into a “running” state (in operation S920) and sets the running CA software object as the object (in operation S930).

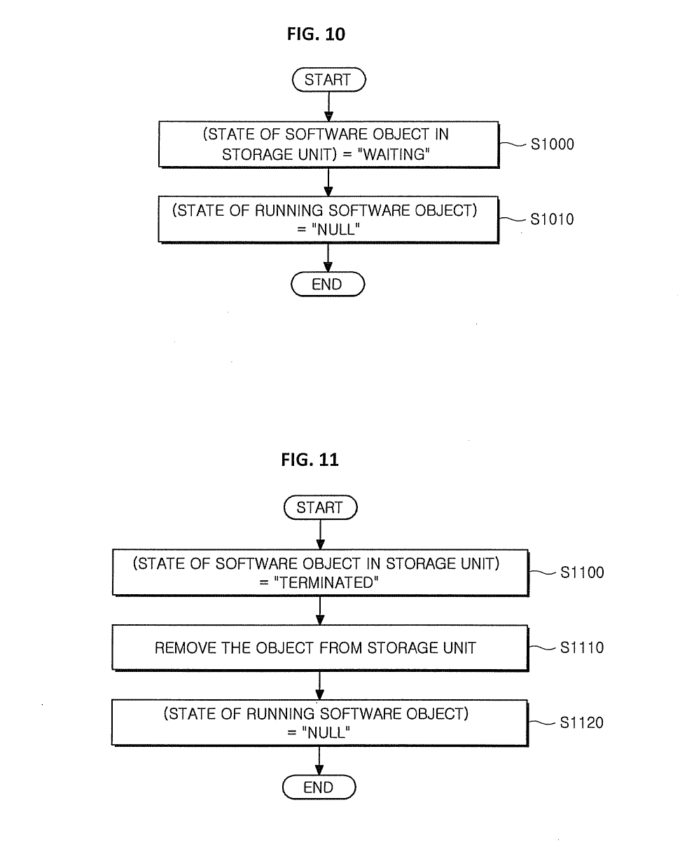

FIG. 10 is a flow diagram illustrating a process for the CA software management unit 260 to pause execution of a CA software object to change the CA software object into a “waiting” state, according to an embodiment of the present invention. FIG. 10 illustrates a process for pausing execution of a running CA software object to change CA software object into a “waiting’ state.

Referring to FIG. 10, the CA software management unit 260 sets the state of a CA software object stored in the CA software storage 264 to a “waiting” state (in operation S1000) and then sets a running CA software object to “null” (in operation S1010).

FIG. 11 is a flow diagram illustrating a process for the CA software management unit 260 to terminate execution of a CA software object, according to an embodiment of the present invention. FIG. 11 illustrates a process for terminating a “running” or “waiting” CA software object.

Referring to FIG. 11, the CA software management unit 260 sets the state of a CA software object stored in the CA software storage 264 to a “terminated” state (in operation S1100) and then removes the CA software object from the CA software storage 264 (in operation S1110). Thereafter, the CA software management unit 260 sets the state of the running CA software object to a “null” state (in operation S1120).

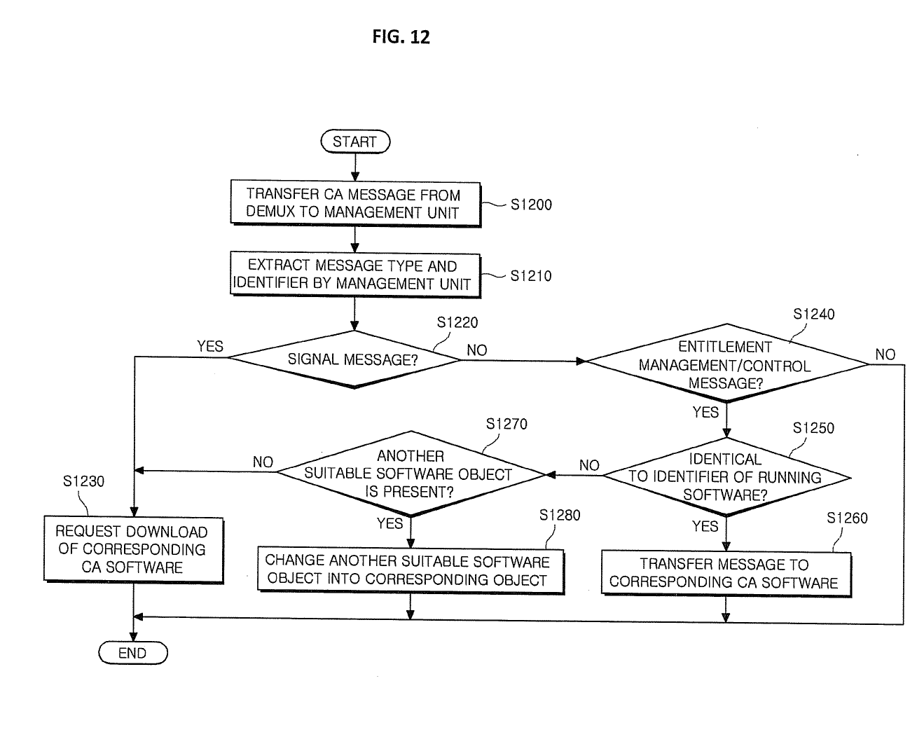

FIG. 12 is a flow diagram illustrating a process for the CA software management unit 260 to analyze and process a CA message, according to an embodiment of the present invention.

Referring to FIG. 12, the DEMUX 250 transfers all of received CA messages to the CA software management unit 260 (in operation S1200). Then, the CA software management unit 260 extracts a message type and the corresponding CA software identifier written in the CA message (in operation S1210).

Thereafter, the CA software management unit 260 determines the type of the CA message (in operation S1220). If the CA message is a signal message for commanding to download a CA message in advance, the CA software management unit 260 requests download of a CA software for the corresponding CA software identifier (in operation S1230).

If the CA message is an entitlement management message or an entitlement control message (in operation S1240), the CA software management unit 260 checks whether the CA software identifier is identical to an identifier of currently-running CA software (in operation S1250). If the CA software identifier is identical to an identifier of a currently-running CA software (in operation S1250), the CA software management unit 260 transfers the message to the corresponding CA software (in operation S1260). On the other hand, if the CA software identifier is different from an identifier of a currently-running CA software (in operation S1250), the CA software management unit 260 checks whether another suitable software object with the identical identifier is present in the CA software storage 264 (in operation S1270). If another suitable CA software object with the identical identifier is present in the CA software storage 264 (in operation S1270), the CA software management unit 260 changes the suitable CA software object into the corresponding object (in operation S1280).

On the other hand, if another suitable CA software object with the identical identifier is present in the CA software storage 264 (in operation S1270), the CA software management unit 260 requests download of the corresponding CA software object.

As described above, the present invention can provide download of CA software in the download-based CA system so that one receiver (e.g., a settop box) can operate a plurality of download softwares. Also, the present invention analyzes the CA-related message to select and execute CA software capable of processing the message among the downloaded CA softwares. If the CA software is not needed any more, the present invention performs the rapid update and software change to another necessary CA software. Thus, it is possible to efficiently manage the execution and change of a plurality of CA softwares.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

What is claimed is:

1. A receiver having a conditional access (CA) function based on software download, the receiver comprising:
a CA software management means for performing an overall management operation including the download, execution, state control and termination of a plurality of CA softwares;
a download means for downloading the CA software from a CA software download server at the request of the CA software management means;
a demultiplexer for receiving scrambled multimedia contents and a CA message and transferring the CA message to the CA software management means; and
a descrambler for receiving a descrambling key extracted from the CA message by means of the CA software and descrambling the scrambled multimedia contents with the descrambling key.

2. The receiver of claim 1, wherein the CA software management means comprises:
a message analysis unit for analyzing the CA message;
a CA software download request unit for downloading the necessary CA software to the download means beforehand or timely; and
a CA software execution management unit for executing the CA software according to the analysis results of the message analysis unit and controlling a state change.

3. The receiver of claim 2, wherein the CA software management means further comprises a storage for storing a plurality of the downloaded CA softwares.

4. The receiver of claim 2, wherein
the CA message includes a CA software identifier;
the message analysis unit checks whether there is a CA software corresponding to the CA software identifier included in the currently-received CA message; and
the CA software download request unit sends a download request to the CA software download request unit if there is no corresponding CA software.

5. A conditional access (CA) system based on software download, the CA system comprising:
a CA server for scrambling multimedia contents and transmitting the scrambled multimedia contents together with a CA message;
having a conditional access (CA) function based on software download; and
a subscriber management unit for managing information about multimedia content service subscribers and transferring the subscriber information to the CA server and the receiver;
wherein the receiver comprising:
a CA software management means for performing an overall management operation including the download, execution, state control and termination of a plurality of CA softwares;
a download means for downloading the CA software from a CA software download server at the request of the CA software management means;
a demultiplexer for receiving scrambled multimedia contents and a CA message and transferring the CA message to the CA software management means; and
a descrambler for receiving a descrambling key extracted from the CA message by means of the CA software and descrambling the scrambled multimedia contents with the descrambling key.

6. A method for managing a conditional access (CA) software executed by a CA software management means in a receiver of a software download-based CA system, the method comprising:
analyzing a CA message that is currently received;
requesting download of a CA software according to the analysis results;
initializing the downloaded CA software; and
controlling a state change of one or more CA softwares that are currently running.

7. The method of claim 6, wherein the analyzing of the CA message comprises:
requesting and receiving a CA message of a corresponding channel from a demultiplexer of the receiver when the receiver is booted;
extracting an identifier of a necessary CA software from the CA message; and
determining a CA software to be beforehand downloaded at the booting time according to the extraction results.

8. The method of claim 6, wherein the analyzing of the CA message comprises:
interpreting a command included in the CA message;
if necessary CA software needs to be beforehand prepared as a result of the interpretation, searching a CA software storage to determine whether there is necessary CA software; and
determining whether to download CA software according to the determination results.

9. The method of claim 6, wherein the analyzing of the CA message comprises:
checking whether a CA software identifier included in the CA message is identical to an identifier of a currently-running a CA software;
if the CA software identifier is different from the identifier of the currently-running CA software, searching a CA software storage to determine whether there is a necessary CA software; and
determining whether to download a CA software according to the determination results.

10. The method of claim 9, wherein if the CA software identifier is different from the identifier of the currently-running CA software, the controlling of the stage change pauses execution of the currently-running CA software immediately after the checking operation.

11. The method of claim 6, wherein the requesting of the download of the CA software comprises:
requesting download of a software object to a download unit according to the analysis results; and
repeating the download request until the request result is successful or until the number of times of download attempt exceeds a predetermined number.

12. The method of claim 6, wherein the initializing of the downloaded CA software comprises:
checking whether a CA software to be initialized is present in a CA software storage;
if the CA software to be initialized is present in the CA software storage, generating an object of the CA software by means of a class loader; and
setting the state of the CA software to “ready” after the generating of the object.

13. The method of claim 12, wherein the initializing of the downloaded CA software further comprises:
determining an initialization mode;
if the initialization mode is an optional mode, determining whether the number of currently-initialized objects is smaller than a predetermined maximum initialization object number and performing the initialization if the number of currently-initialized objects is smaller than the predetermined maximum initialization object number; and
if the initialization mode is a mandatory mode, performing the initialization mandatorily.

14. The method of claim 13, wherein if the number of currently-initialized objects is equal to or larger than the predetermined maximum initialization object number, the mandatory performing of the initialization changes at least one of currently-initialized objects into a null state and initializes a new object.

15. The method of claim 6, wherein for execution of an object of the CA software, the controlling of the stage change comprises:
determining whether the object to be executed is initialized;
initializing the object if the object is not yet initialized;
setting the state of the object to a running state; and
setting the object as a running object.

16. The method of claim 6, wherein for restart of an object of the CA software, the controlling of the stage change comprises:
checking whether a corresponding object is in a “waiting” state;
initializing the object;
setting the state of the object to a “running” state; and
setting the object as a running object.

17. The method of claim 6, wherein for change of an object of the CA software into a “waiting” state, the controlling of the stage change comprises:
checking whether a corresponding object is in a “running” state;
transferring a message for requesting an association release for the object to a descrambler;
setting the state of the object to a “waiting” state upon receipt of a response message for the request; and
setting the state of the object to a “null” state.

18. The method of claim 6, wherein for termination of execution of an object of the CA software, the controlling of the stage change comprises:
detecting the state of the object and setting the state of the object to a “terminated” state if the object is in a “running” state; and
removing the CA software from a CA software storage.
